(19) United States
(12) Patent Application Publication
(10) Pub. No.: US 2010/0048071 A1
(43) Pub. Date: Feb. 25, 2010

(54) WAVE RIDING BOARDS

(76) Inventor: Vitor Emanuel Lopes Nascimento, East Ham (GB)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 12/520,595

(22) PCT Filed: Dec. 24, 2007
(86) PCT No.: PCT/GB2007/005014

§ 371 Date: Jun. 22, 2009

(30) Foreign Application Priority Data
Dec. 22, 2006 (GB) GB 0625834.7
Aug. 30, 2007 (GB) GB 0716957.6

(51) Int. Cl. B63B 35/79; F21L 4/00

(52) U.S. Cl. 441/74; 362/183

(57) ABSTRACT

A wave riding board comprises at least one portion made of a plastics material that can switch between a condition in which it is transparent or translucent and a condition in which it is substantially opaque and switching for switching the plastics material between those conditions.

### FIELD OF THE INVENTION

The invention relates to wave riding boards including surfboards, long boards, sailboards, wind surfboards, kite surfboards, kneeboards, paddleboards and boogie boards.

### BACKGROUND TO THE INVENTION

Surfboards and similar such wave riding boards are typically constructed as a rigid foam core covered by a hard resin material reinforced with fibre or as a hollow structure made from a fibre-reinforced plastics material and internally reinforced by ribs or webs.

Board riders, particularly surfers, generally practice their sport in daylight. This is particularly so for competitive surfing since visibility is required for judging and spectating.

U.S. Pat. No. 6,431,933 discloses an illuminated surfboard comprising a solid riding board, an electro-luminescent sheet positioned on the riding board and a translucent resin layer covering the electro-luminescent sheet.

US2004/0212980 discloses risers that include a transparent or translucent plane, a power source and LED light sources for illuminating the transparent/translucent plane and that the risers can be fitted to a surfboard.

US2005/0064774 discloses forming grooves in the solid riding board of a sports board, such as a surfboard, fitting an electro-luminescent wire in the grooves and providing a transparent or translucent protective layer over the board surface and electro-luminescent wires.

### SUMMARY OF THE INVENTION

The invention provides a wave riding board comprising a hollow body and at least one illumination device operable to illuminate the interior of the hollow body, the hollow body having at least one portion that is transparent or translucent.

The invention also includes a wave riding board comprising at least one portion made of a plastics material that can switch between a condition in which it is transparent or translucent and a condition in which it is substantially opaque and switching for switching said plastics material between said conditions.

The invention also includes a wave riding board comprising a shell having an interior accessible by an aperture and an inflatable body that is insertable into said shell through said aperture.

The invention also includes a wave riding board comprising at least one illumination device for radiating visible light and remotely controllable switching for switching said at least one illumination device.

### BRIEF DESCRIPTION OF THE DRAWINGS

In order that the invention may be well understood, some embodiments thereof, which are given by way of example only, will now be described with reference to the drawings in which:

FIG. 1 is a perspective partially cutaway view of a wave riding board;

FIG. 2 is a partial section on line II-II in FIG. 1;

FIG. 3 is a schematic illustration of an illumination device of the wave riding board of FIG. 1;

FIG. 4 shows some modifications that can be made to the wave riding board shown in FIG. 1;

FIG. 5 is an exploded perspective view of another wave riding board;

FIG. 6 is a section on line VI-VI in FIG. 5;

FIG. 7 is an exploded perspective view of yet another wave riding board; and

FIG. 8 is a schematic cross-section illustration of a portion of a wave riding board that is controllably switchable between a transparent or translucent condition and an opaque condition.

### DETAILED DESCRIPTION OF THE EMBODIMENTS

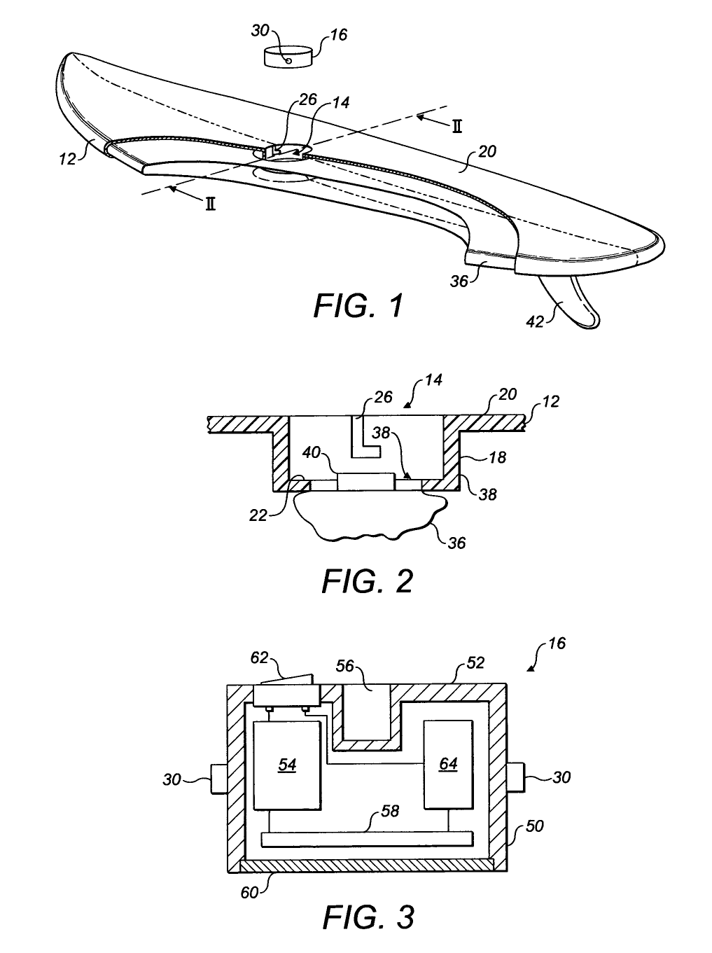

Referring to FIGS. 1 and 2, a wave riding board in the form of a surfboard 10 comprises a hollow body in the form of a shell 12 that is substantially transparent. The shell 12 is relatively rigid and made of a polymer such as a transparent polycarbonate and may be provided with a resin or fibreglass coating that is also transparent or translucent. Optionally, the polycarbonate may have its transparency reduced by, for example, frosting, being coloured or the application of laser print designs.

The shell 12 has a centrally disposed recess 14 for housing an illumination device 16. As best seen in FIG. 2, the recess 14 is defined by a circular wall 18 that depends from the upper, or deck, surface 20 of the shell 12 and an annular wall 22 that extends perpendicularly from the lower end of the circular wall 18 to define a ledge on which the illumination device 16 seats. A pair of L-shaped grooves 26 is provided in the circular wall 18 (only one of the grooves 26 is visible in the drawings). The grooves 26 are disposed opposite one another for engagement by diametrically opposed projections 30 provided on the illumination device 16. The grooves 26 and projections 30 provide a twist-lock securing mechanism by means of which the illumination device 16 is releaseably securable in the recess 14. As an alternative, the projections 30 may be provided on the circular wall 18 and the grooves 26 in the circumferential wall of the illumination device.

The shell 12 houses an inflatable body in the form of a bag 36 that when inflated fills substantially all of the interior of the shell. The bag 36 is preferably a little wider and longer than the shell 12 so that when inflated it presses against the inside of the shell to provide support for the shell. The bag 36 is made of a suitable flexible material, for example PVC, and is insertable into the shell 12 through an aperture 38 defined by the annular wall 22. The bag 36 is made of a transparent or translucent material that allows light from the illumination device to illuminate the interior of the shell. The bag 36 is provided with a valve 40. The underside of the illumination device 16 may be provided with a recess for receiving at least a portion of the valve 40.

The underside of the shell 12 is optionally provided with one or more formations for improving the stability of the wave riding board 10. In the embodiment, the shell 12 has an integral stabilising fin 42.

Referring to FIG. 3, the illumination device 16 comprises a cylindrical housing 50 configured to fit within the recess 14 such that its upper surface 52 is either substantially flush with the adjacent portions of the deck surface 20 or just below adjacent portions of the deck surface. Within the housing 50 there is power supply in the form of a rechargeable battery 54. The upper surface 52 of the housing 50 includes a formation in the form of a recess 56 for receiving a mating projection of a charger base (not shown) similar to the charger bases used to recharge electric toothbrushes. By means of the connection between the projection of the charger base and recess 56, the battery 54 can be recharged when spent. This form of battery charging is well known and so will not be described in further detail here.

The illumination device 16 includes a dc light unit, for example, a plurality of LEDs 58. The LEDs 58 are held in the housing 50 at positions in which the illumination they provide is directed into the interior of the shell 12. To allow light from the LEDs 58 to illuminate the interior of the shell 12, the housing 50 is made of a transparent material or is at least transparent in the area around the LEDs 58. The LEDs 58 may be the same colour or different colours.

The LEDs 58 may be directly connected to the battery 54 such that they are switched off by removing the battery or inserting an insulation piece between a terminal of the battery and a connection to the LEDs 58. Using such an arrangement, switching is accomplished by removing the illumination device 16 from the recess 14 and accessing the interior of the housing 50 by removing a cover 60 from the main body of the housing. However, it is preferred that a suitably waterproofed rocker switch 62 is provided between the battery and LEDs 58 and is positioned such that it can be accessed by the rider while the surfboard is in use.

Optionally, a control unit 64 can be included in the lighting circuitry. The control unit 64 can be configured to provide various effects such as flashing or strobing of the LEDs 58.

In use of the surfboard 10, the rider inflates the bag 36 to a suitable pressure. It will be appreciated that by varying the pressure in the bag 36, the rider can control the stiffness (and so the flexure and bounce) of the surfboard 10. For example, a relatively lower pressure in the bag will increase the flex and bounce of the surfboard providing a slingshot effect and making the board feel more responsive and alive.

When the rider is satisfied with the set-up of the surfboard, he/she can fit the illumination device 16 into the recess 14. The switch 62 can then be operated to provide illumination of the surfboard as desired.

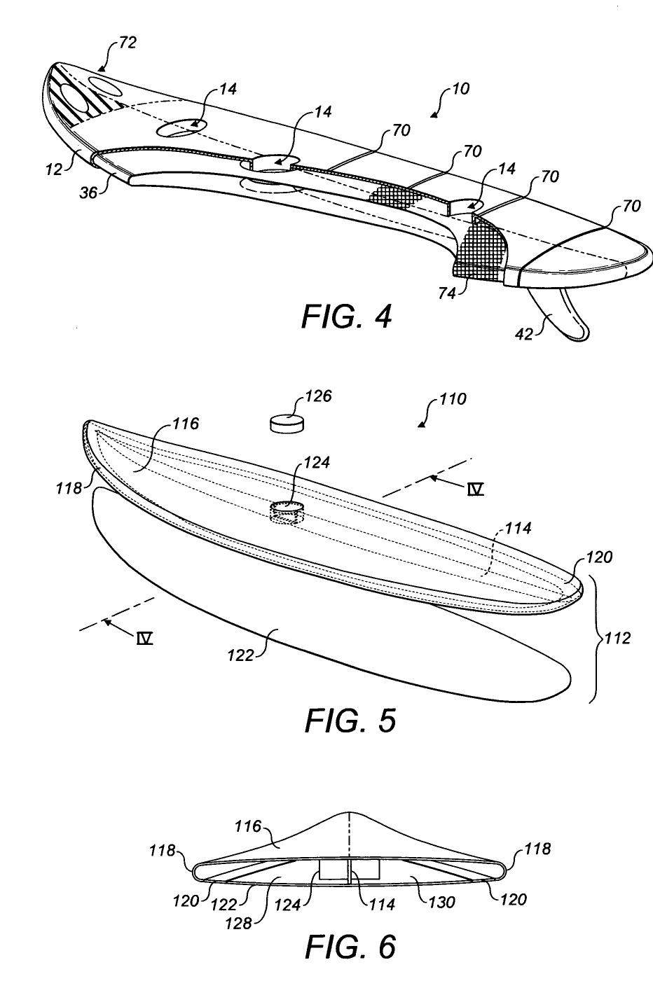

FIG. 4 shows some modifications that can be made to the surfboard 10. For example, the shell 12 may define multiple recesses 14 for respective illumination devices 16. This should ensure more uniform illumination of the interior of the shell 12 throughout the length of the board and could be used to provide different colour lighting along the length of the board. The shell 12 may be provided with composite reinforcing strips 70. The reinforcing strips 70 may take the form of hoops of carbon fibre material as shown. Alternatively, the reinforcing strips may extend in the lengthways direction of the board generally parallel to the longitudinal axis of the board or diagonally. In the latter case the diagonal strips may extend in two directions to form a criss-cross pattern. As shown at the bow of the surfboard, the shell 20 may be printed with different patterns 72 to selectively vary the transparency of the shell 12. Yet another alternative would be to vary the transparency of the bag 36. One way of doing this would be to manufacture the bag by joining together segments of transparent and translucent (for example coloured or frosted materials) materials. Two segments 74 of a coloured material incorporated in the bag 36 are shown. The bag may also include segments that are substantially opaque.

Referring to FIGS. 5 and 6, another wave riding board 110 comprises a hollow body in the form of a monocoque shell 112 with a longitudinally extending reinforcing rib 114. The shell 112 includes an upper portion that is made up of an upper, or deck, surface 116, curved rails 118 formed around the periphery of the deck surface and a flange 120 that extends from the lower end of the rails and generally parallel to the deck surface. The deck surface 116, rails 118 and flange 120 are formed as one piece from a polymer such as a transparent polycarbonate and may be provided with a resin or fibreglass coating that is also transparent or translucent. Optionally, the polycarbonate may have its transparency reduced by, for example, frosting, being coloured or the application of laser print designs. The shell 112 is completed by a lower panel, or skin, 122 that is attached and sealed to the flanges. The lower skin 122 is preferably formed from the same material as the deck surface 116. The lower skin 122 may be transparent, translucent or opaque.

The reinforcing rib 114 extends along the longitudinal axis of the surfboard 110 and is in two parts; one on either side of a recess 124 formed in the deck surface 116 for housing an illumination device 126. The reinforcing rib 114 depends from and is generally perpendicular to the deck surface 116. As best shown in FIG. 6, the reinforcing rib 114 divides the interior of the shell 112 into a first, or left-hand, chamber 128 and a second, or right-hand, chamber 130.

The structure of the recess 124 and of the illumination device 126 is preferably the same as that of the corresponding parts 14 and 16 of the surfboard 10. Similarly, the shell 112 may be modified in the ways illustrated in FIG. 4. Another possibility is that the some or all of the interior of the shell 112 is coated with a fluorescent material and the illumination device 126 is configured to radiate light at a wavelength that causes excitation of the fluorescent material and causes those parts of the shell coated with the material to glow through the shell. The division of the shell interior into the two chambers 128, 130 allows the possibility of having an illumination device 126 that puts different coloured light into the two chambers. Alternatively, respective illumination devices could be provided for the chambers 128, 130. The shell interior may be further subdivided by additional ribs and each chamber formed by the ribs illuminated with a different colour light.

Although not shown, the surfboard 110 may be provided with a pair of inflatable bodies similar to the bag 36 of the surfboard 10. To facilitate insertion into the shell 112, separate insertion apertures may be provided, preferably by providing respective recesses 124.

Both embodiments may be modified by making the all or a part of the shell 12, 112 from a plastics material whose transparency can be adjusted by the rider. For example, in the case of the shell 12, the entire shell could be made of such a material. In the case of the shell 112, the upper portion 116, 118, 120 may be formed of such a material while the lower skin is optionally formed of a different material, which might be opaque. A board incorporating such a material would be provided with means, including switching, to allow the rider to adjust the transparency of the transparent material. One such material is a grade of Makrolon®, which is a product of the Bayer group of companies, and incorporates liquid crystal technology such that it can be switched between a condition in which it is highly transparent and a condition in which it is opaque. Switching of the transparency of the Makrolon® may be by means of switching provided on the board or by a remote switching system.

In another embodiment that is not illustrated, the hollow body is in the form of an inflatable body structured such that when inflated it has the shape of a board suitable for wave riding. At least a portion, preferably all, of the hollow body is transparent or translucent. The hollow body has a housing for an illumination device secured into a hole made in the body material. Preferably, the housing would have features similar to the recess 14 so that it would be able to receive an illumination device, such as the illumination device 16, and include an integral switch for switching the illumination device. The housing is arranged such that when an illumination device such as the device 16 is fitted therein, the illumination device radiates light into the interior of the hollow body to illuminate the hollow body. The arrangement is such that light from the interior of the hollow body radiates through the transparent (or translucent) portions thereof.

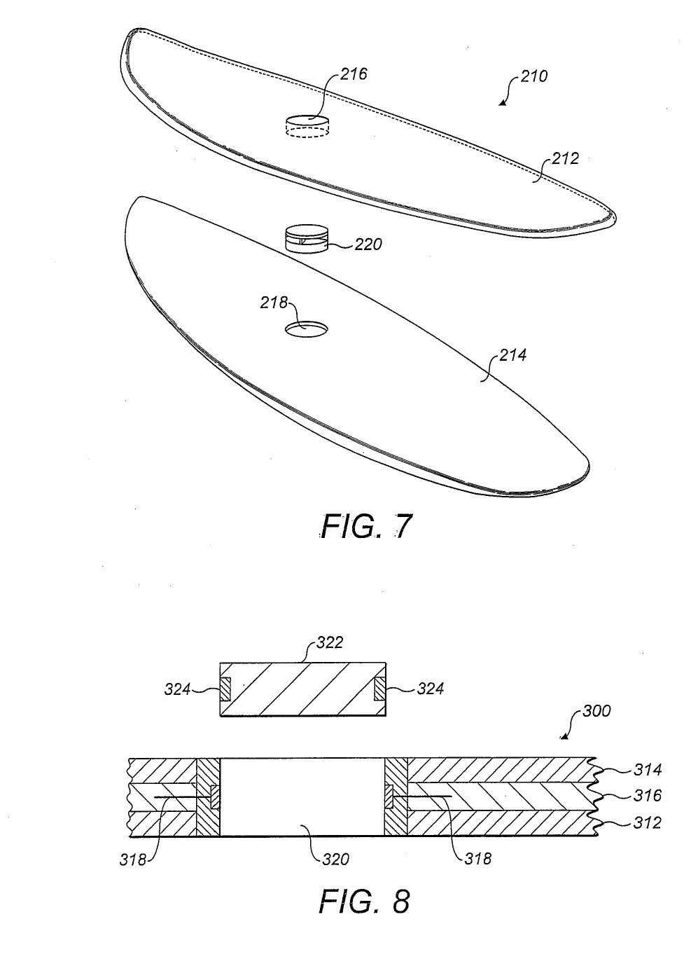

Referring to FIG. 7, another surfboard 210 comprises a deck portion 212 and a hull portion 214. The deck portion 212 is bonded to the hull portion 214 to form a laminate structure. The deck portion 212 is relatively thin and made of a material such as Makrolon® whose transparency can be user adjusted by operation of a switch. The hull portion 214 is relatively thicker than the deck portion 212 and is made of a material that is lighter (less dense) than Makrolon so as to minimise the weight of the surfboard 210 and maintain its buoyancy. The material from which the hull portion 214 is made is also transparent, or at least translucent. Although not shown, the hull portion may be provided with buoyancy chambers in the form of recesses formed in its upper surface.

The deck portion 212 is provided with a through-hole 216 that is positioned such that it is in-line with a recess 218 formed in the upper surface of the hull portion 214. The recess 218 is configured to releaseably engage an illumination device 220 in similar fashion to the recess 14 and illumination device 16 shown in FIG. 1. The illumination device 220, which in basic construction may be the same as the illumination device shown in FIG. 3, is configured to radiate light into the deck portion 212 and hull portion 214. The result is that when switched on, the illumination device 220 can light up the whole length of the surfboard 210.

When the deck portion 212 and hull portion 214 are both made of a material that is transparent, both the rider and any spectator can be given the impression the rider is walking on water. However, if the rider wishes the board to be seen, he/she has only to switch the deck part to its non-transparent mode.

The surfboard 210 could be modified by forming a recess in the upper surface of the hull portion 214 to receive the deck portion 212.

As an alternative to having an illumination device 220 as shown, the wave riding board could be fitted with one or more chains of LEDs, miniature incandescent bulbs or electro-luminescent light sources such as the Lytec® electro-luminescent wire housed in one or more grooves provided in the hull portion 214. The Lytec® electro-luminescent wire is described in U.S. Pat. No. 5,869,930 and is a flexible elongate filament of approximately 3 mm diameter that emits light over its entire length when supplied with ac electrical power at one end. Where the light sources can be powered by dc electrical power, a power pack similar to the power pack incorporated in the illumination device could be used and fitted into the recess 218. The battery 54 would supply electricity to the light sources via suitable leads extending from the housing 50 for connection to the light sources. In this case, the power pack housing may be permanently fitted to the board, in which case, provision would be made for recharging with the battery while still fitted in the power pack or for removing the battery. For light sources requiring an ac electrical supply, the power pack would additionally comprise an inverter.

In the embodiments, operation of the illumination devices 16, 126, 220 is controlled by a rocker switch. It will be understood that other forms of switch can be used. For example, switching may be by way of a pair of contacts on an exposed surface of the illumination device that make a circuit that closes the switch when immersed in water. Alternatively, the illumination devices may be provided with an attitude switch that operates to provide a connection between the battery and lighting unit when the surfboard is in its normal use attitude with the deck surface 20. In this embodiment, the rider can turn off the illumination by simply inverting the board, such as would be done when fitting the board to a vehicle roof rack. Turning the board into its normal use attitude would cause the switch to close and the illumination device to illuminate the interior of the board. Yet another alternative would be to provide remote controlled switching operable, for example, by radio or infrared signals. In this case, a remote controller for controlling the switching could be provided on a wristband and may be equipped to serve as a timepiece (watch) optionally equipped to provide other functions incorporated in known timepieces. Alternatively, the remote controller may be arranged such that it can be clipped to a waistband or the like. Yet another alternative would be to fit the illumination device with a push-switch that is biased to an open position and is pushed into a closed position by pressing against the recess when the illumination device is fitted to the board.

In the embodiments, the housing for the illumination device is accessible from the deck surface. It will be appreciated that the housing could be formed such that it is instead accessible from the underside of the board. Using the illustrated illumination device, this would result in the switch 62 being inaccessible while the board is in use. However, it will be understood that in some embodiments, a switch could be installed for access from the deck surface with contacts that are engaged by the illumination device when it is secured in the housing.

In the illustrated embodiments, the illumination device is releaseably securable in the recess in which it is housed by means of a bayonet-type fitting. It will understood that other securing means can be used. For example, the wall 18 of the recess and circumferential wall of the housing 50 could be provided with complementary thread-like formations that would allow the illumination device to be screwed into the recess. Alternatively, the illumination device could be secured in the recess by a lid (not shown) that engages the shell to close the recess. The lid would preferably by provided with means for pressing the illumination device into the recess, for example, a resilient pad or one of more springs.

It will be appreciated that while the illumination device 16 is configured for recharging using a charger base of the type used for recharging electric toothbrushes, other configurations can be used. Thus, the illumination devices may be provided with formations for engaging with any suitable charger base. Alternatively, the illumination device may be provided with a socket for receiving a fitting on the end of cable similar to those used for charging mobile telephones. It will be appreciated that making the illumination device rechargeable as described allows the device to be made as a sealed unit so that water ingress should not be a problem. However, it is to be understood that while not preferred, the illumination device could be configured to use any standard non-rechargeable battery and made so that it can be opened to allow battery replacement.

It will be appreciated that the embodiments allow the possibility of nighttime recreational and competitive surfing by providing surfboards having internal illumination that enables spectators and judges to observe the performance of the rider despite the absence of daylight.

It will be appreciated that the internal illumination provided in the embodiments provides a rideable board having at least an illuminated deck surface that can provide a visual spectacle to observers and enhance enjoyment of the board rider.

It will be appreciated that by making the entire board from a material such as Makrolon®, it is possible to provide a board that provides various attractive visual effects. For example, the board can be used in transparent mode giving the rider and watchers the impression he/she is walking on water while at the same time allowing the transparency to be switched off so that the rider can see the board when he/she wants to.

It will be appreciated that in embodiments in which the shell is fitted with one or more inflatable bodies, the transparent or translucent shell of the wave riding board can be made plain and the rider can quickly and easily apply new decoration to his/her board by fitting inflatable bodies that are decorated differently. Thus, the inflatable body or bodies can be used to tune the performance of a board and provide different decorative effects.

It will be appreciated that for embodiments having remotely controllable switching for the illumination device(s) and remotely controllable switching for switching the plastics material whose condition can be switched, the remote controls may be combined into a single unit, which as previously described may be fitted with a wrist band and, optionally, equipped to incorporate functions provided by known timepieces and the like.

It will be appreciated that all or parts of the wave riding boards may be treated with a composition, typically phosphor-based, that glows in the dark.

It will be appreciated that the wave riding boards can have rails provided with a composite (for example carbon fibre) or wooden reinforcing strip to add to the overall strength and, so, the flex and performance of the board. The reinforcing strips may be provided on the exterior or the board, on the interior of the shell or, in the case of an inflatable body, within the inflatable body.

FIG. 8 shows in schematic cross-section a portion of the skin 300 of a wave riding board that can be switched between a transparent or translucent condition and an opaque condition. The skin 300 comprises inner and outer layers 312, 314 made of a transparent or translucent material, for example a polycarbonate, that are disposed in spaced apart relation and an electrically excitable material 316 disposed between the inner and outer layers. The electrically excitable material 316, which may incorporate liquid crystal technology, responds to switched electrical excitation by switching between a translucent or transparent condition and an opaque condition. As previously indicated, the material may be a grade of Makrolon® that is made and sold by the Bayer group of companies. In one embodiment, electrodes 318 extend from an aperture 320 formed in the skin 300 into the material 316. A suitable power unit 322, which may be similar in construction to the illumination devices previously described, may be provided for releasable fitting in the aperture 320. The power unit 322 is provided with contacts 324 for engaging the electrodes 318 to provide circuit for an electrical excitation current. The power unit 322 may be provided with a suitable switch 326 to allow the rider to control the excitation of the material 316. Alternatively, the power unit 320 may be equipped for remote switching as previously described in connection with the illumination devices. It will understood that the power unit may permanently fitted to the wave riding board or may be incorporated in an illumination device similar to those previously described.

It will be appreciated that embodiments of the invention provide a wave riding board comprising at least one portion made of a material that can be switched between a condition in which it is transparent or translucent and a condition in which it is substantially opaque and switching for switching said material between said conditions

1. A wave riding board comprising at least one portion made of a plastics material that can switch between a condition in which it is transparent or translucent and a condition in which it is substantially opaque and switching for switching said plastics material between said conditions.

2. A wave riding board as claimed in claim 1, comprising a hull portion and a deck portion that is joined to said hull portion, said deck portion being made of said plastics material.

3. A wave riding board as claimed in claim 2, wherein said hull portion is made of a material that is transparent or translucent.

4. A wave riding board as claimed in claim 2, wherein said deck portion and hull portion define at least one chamber therebetween.

5. A wave riding board as claimed in claim 4, further comprising an inflatable body fittable into a said chamber.

6. A wave riding board as claimed in claim 1, further comprising at least one illumination device for illuminating at least said plastics material.

7. A wave riding board as claimed in claim 6, wherein said at least one illumination device is releaseably securable to the wave riding board.

8. A wave riding board as claimed in claim 6, wherein said at least one illumination device comprises a rechargeable power supply and formations for connecting the power supply to a charger base.

9. A wave riding board as claimed in claim 6, further comprising remotely controllable switching for switching said at least one illumination device.

10. A wave riding board as claimed in claim 1, wherein said plastics material comprises a elements that are switchable between said conditions in response to an electrical excitation current.

11. A wave riding board as claimed in claim 10, wherein said element comprise liquid crystals.

12. A wave riding board as claimed in claim 1, wherein said plastics material is a grade of Makrolon®.

13. A wave riding board as claimed in claim 1, wherein said switching for switching said plastics material between said conditions is remotely controllable.

14. A wave riding board comprising a hollow body and at least one illumination device operable to illuminate the interior of the hollow body, the hollow body having at least one portion that is transparent or translucent.

15. A wave riding board as claimed in claim 14, wherein said hollow body is a relatively rigid shell and further comprising an inflatable body housed within said shell.

16. A wave riding board as claimed in claim 15, wherein said shell comprises a single member having an access aperture for said inflatable body.

17. A wave riding board as claimed in claim 16, wherein said shell defines a recess in which a said illumination device is received and said access aperture is provided in said recess.

18. A wave riding board as claimed in claim 14, wherein said hollow body defines a recess for housing a said illumination device.

19. A wave riding board as claimed in claim 17, wherein said illumination device is releaseably securable in said recess.

20. A wave riding board as claimed in claim 14, wherein the or at least one said illumination device comprises a rechargeable power supply and formations for connecting the power supply to a charger base.

21. A wave riding board as claimed in claim 14, wherein a light transmitting property of said at least one transparent or translucent portion is user adjustable.

22. A wave riding board as claimed in claim 21, wherein the or at least one transparent or translucent portion can be user adjusted to be substantially opaque.

23. A wave riding board as claimed in claim 21, further comprising a switching device for switching said light transmitting property.

24. A wave riding board as claimed in claim 14 in which substantially all of said hollow body is transparent or translucent.

25. A wave riding board as claimed in claim 14, further comprising remotely operable switching for switching said at least one illumination device.

26. A wave riding board comprising at least one illumination device for radiating visible light and remotely controllable switching for switching said at least one illumination device.

27. A wave riding board as claimed in claim 26 in combination with a remote controller for remotely controlling said switching, said remote controller being provided on a wristband.
